(19) United States
(12) Patent Application Publication
(10) Pub. No.: US 2011/0120030 A1
(43) Pub. Date: May 26, 2011

(54) Skylight screen

(75) Inventors: Harold L. Swindell, III, Mount Laurel, NJ (US); Murray C. Mumau, Lyndonville, NY (US); Brian D. Stickler, Lyndonville, NY (US); Jan C. Vanning, Norristown, PA (US)

(73) Assignees: Safety Rail Source, LLC; Kee Safety, Inc.

(21) Appl. No.: 12/592,222

(22) Filed: Nov. 20, 2009

(51) Int. Cl. E06B 3/26

(52) U.S. Cl. 52/202

(57) ABSTRACT

A screen for a skylight which is mounted on a substantially flat roof and which includes a frame having spaced apart vertical walls extending upwardly from the roof. The screen includes a plurality of longitudinal bars and a plurality of transverse bars secured thereto so as to form a plurality of rectangular openings. The transverse bars having a central portion forming an arch that is adapted to overlie the skylight. The transverse bars also include end portions having a substantially vertical section merging into the central portion and a substantially horizontal end section extending outwardly. The end sections are adapted to act as a foot allowing said screen to rest on and be supported by the roof. The transverse rods also include an intermediate section between the vertical section and the horizontal section that is spaced from the corner formed between the roof and each of the vertical walls of the skylight frame. A plurality of clips secure the vertical section of at least some of the transverse rods to the space apart vertical walls of the skylight frame.

### BACKGROUND OF THE INVENTION

The present invention is directed toward a skylight screen and more particularly, toward an improved skylight screen that is stronger and easier to install than many prior art screens.

Skylights come in various shapes and sizes although the majority are flat and rectangular or plastic domed with a rectangular base. In addition, the majority of installed skylights are on relatively flat roofs of schools, warehouses, and manufacturing plants and the like. Skylights on relatively flat roofs present a particular hazard as persons on the roof may stumble, back onto, attempt to sit on the skylight, resulting in the person falling through the skylight. Most skylights are not designed to support the weight of a person. Thus, a safety guard or railing is required to prevent persons from breaking the skylight and falling through the skylight opening.

One means for protecting against a person inadvertently falling through a skylight is to install a wire mesh or screen above the skylight. Examples of such screens are shown in U.S. Pat. Nos. 1,233,530 and 1,236,008 which disclose wire mesh screens positioned a short distance above a flat glass skylight and folded over the skylight frame. The wire mesh is stretched across the skylight and attached to lugs mounted on vertical faces of the skylight frame.

The Occupational Safety and Health Administration (OSHA) has recognized the dangers posed by skylights and has promulgated requirements for a standard skylight screen. OSHA requires that skylight screens be of such construction and mounting that they are capable of withstanding a load of at least 200 pounds applied perpendicularly at any one area on the screen. They are also required to be of such construction and mounting that under ordinary loads or impacts, they will not deflect downward sufficiently to break the glass below them. The construction must be of grillwork with openings not more than 4 inches long or of slatwork with openings not more than 2 inches wide.

U.S. Design Pat. No. 354,817 and U.S. Pat. No. 5,237,788 illustrate existing skylight screens which comply with OSHA. Working on roof openings normally occurs in hard to reach locations or in close confines. It is extremely difficult to assemble multiple piece assemblies in these locations. The invention shown in U.S. Pat. No. 5,237,788 is extremely complex in its construction and requires considerable expense to construct. It is also particularly difficult to assemble.

The invention shown in U.S. Design Pat. No. 354,817 provides a good, safe construction but requires welding skills to permanently secure the grid work to the side brackets. Again, placement and use of welding equipment at the work site makes attachment difficult.

Another prior art attempt to comply with the OSHA requirements was a product sold under the trade name FALLGUARD produced by Plasteco, Inc. of Houston, Tex. This prior art device comprises a pre-rolled/formed steel mesh in an arch shape, which is mounted on specially extruded aluminum rails. The product, however, has several shortcomings. First, it is made of two components which must be manufactured to special order. In addition, the product can only be permanently installed and, therefore, cannot be installed temporarily for work on the roof and then removed. Thirdly, should the skylight or roof opening be of any nonstandard dimension, the device will not fit correctly.

Perhaps the best overall prior art device is shown in U.S. Pat. No. 6,209,271. While the device of that patent is effective, it still suffers from several deficiencies. Most significant is that the screen must be attached to a rigid support that is first attached to and supported by the skylight frame. In some cases, it is difficult to secure the rigid support to the skylight frame. In addition, the frame, in some cases, may not be capable of supporting the weight of a workman who may fall onto the screen, thereby making the same ineffective.

There is, therefore, a need for a light weight, and easily installed skylight screen that meets with OSHA requirements. The device should also be economical to produce, to purchase and to install.

### SUMMARY OF THE INVENTION

The present invention is designed to overcome the deficiencies of the prior art discussed above. It is an object of the present invention to provide a new and improved skylight screen.

It is another object of the present invention to provide a skylight screen that can be easily installed.

It is a further object of the present invention to provide a skylight that, in combination with the skylight, is stronger than previous screens.

It is a still further object of the present invention to provide a skylight that is supported by the roof and which accommodates roofing material that extends from the roof surface to the skylight frame.

In accordance with the illustrative embodiments, demonstrating features and advantages of the present invention, there is provided a screen for a skylight which is mounted on a substantially flat roof and which includes a frame having spaced apart vertical walls extending upwardly from the roof. The screen includes a plurality of longitudinal bars and a plurality of transverse bars secured thereto so as to form a plurality of rectangular openings. The transverse bars having a central portion forming an arch that is adapted to overlie the skylight. The transverse bars also include end portions having a substantially vertical section merging into the central portion and a substantially horizontal end section extending outwardly. The end sections are adapted to act as a foot allowing said screen to rest on and be supported by the roof. The transverse rods also include an intermediate section between the vertical section and the horizontal section that is spaced from the corner formed between the roof and each of the vertical walls of the skylight frame. A plurality of clips secure the vertical section of at least some of the transverse rods to the space apart vertical walls of the skylight frame.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form that is presently preferred; it being understood that the invention is not intended to be limited to the precise arrangements and instrumentalities shown.

FIG. 1 is a front top perspective view of the skylight screen of the present invention in place over a skylight;

FIG. 2 is an end elevational view thereof;

FIG. 3 is a cross sectional view of a portion of the invention taken through the line 3-3 of FIG. 1;

FIG. 4 is a front elevational view similar to FIG. 2 but of the screen only;

FIG. 5 is a side elevational view thereof, and

FIG. 6 is a front top perspective view similar to FIG. 1 but of the screen only.

### DETAILED DESCRIPTION OF THE PREFERRED EMBODIMENT

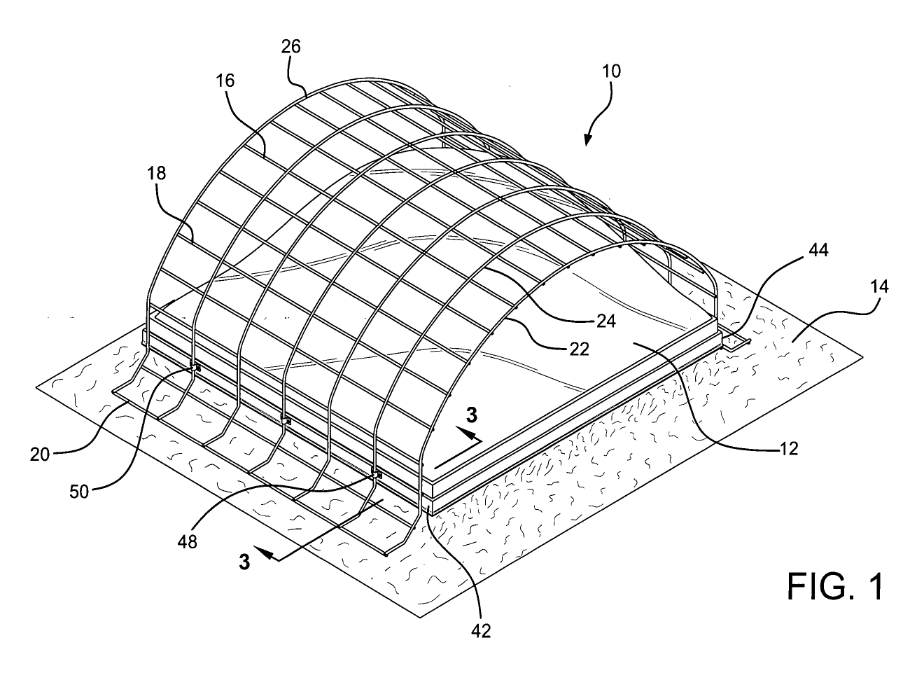

Referring now to the drawings in detail wherein like reference numerals have been used throughout the various figures to designate like elements, there is shown in FIG. 1 a skylight screen constructed in accordance with the principles of the present invention and designated generally as 10. The screen 10 is shown protecting the skylight 12 on a flat roof 14.

The skylight screen 10 of the present invention essentially includes a plurality of longitudinal metal bars such as shown at 16, 18 and 20 and a plurality of transverse metal bars such as shown at 22, 24 and 26. The longitudinal bars are welded or otherwise secured to the transverse bars so as to form a grid pattern or grill work of rectangular shaped openings as is otherwise well known in the art. The number of longitudinal bars and the number of transverse bars will be determined by the size and shape of the skylight 12.

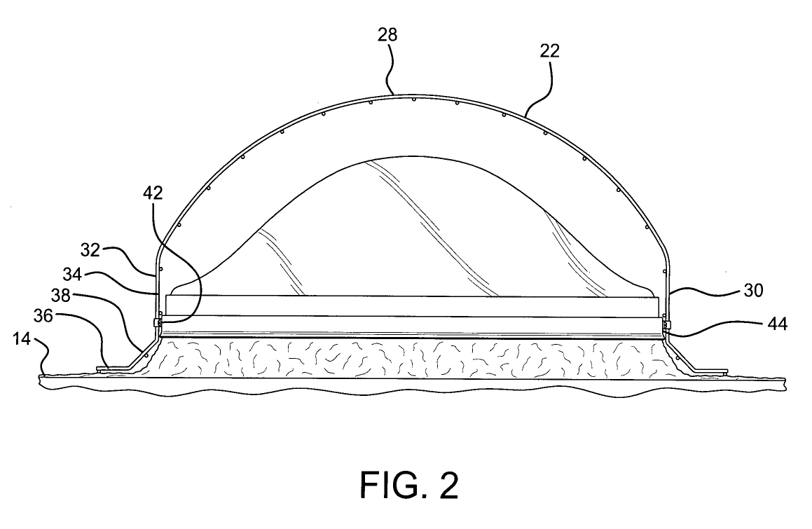

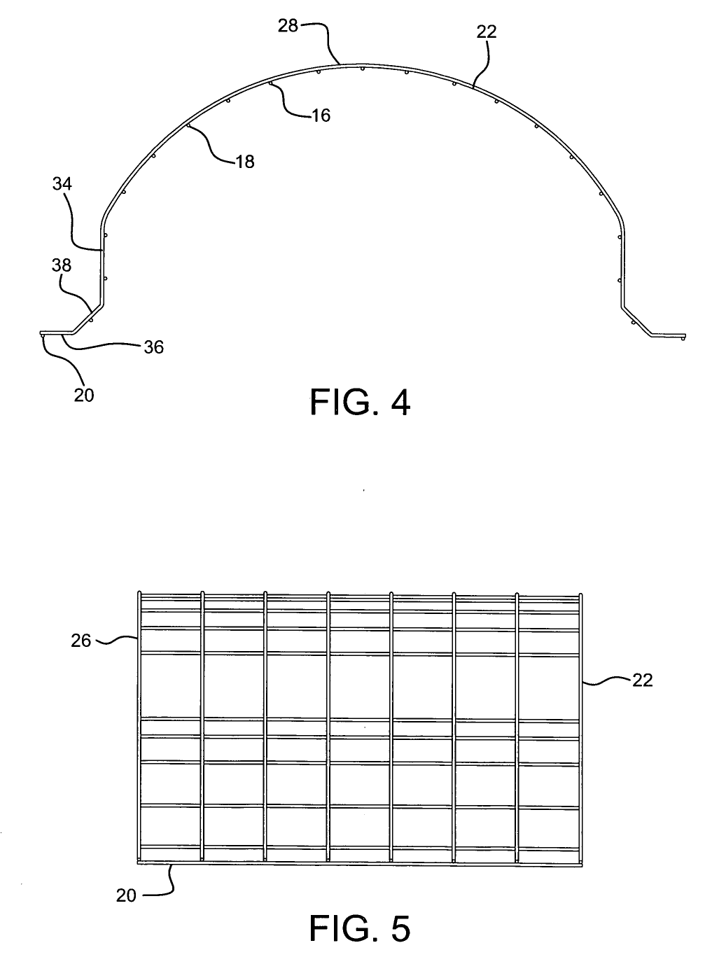

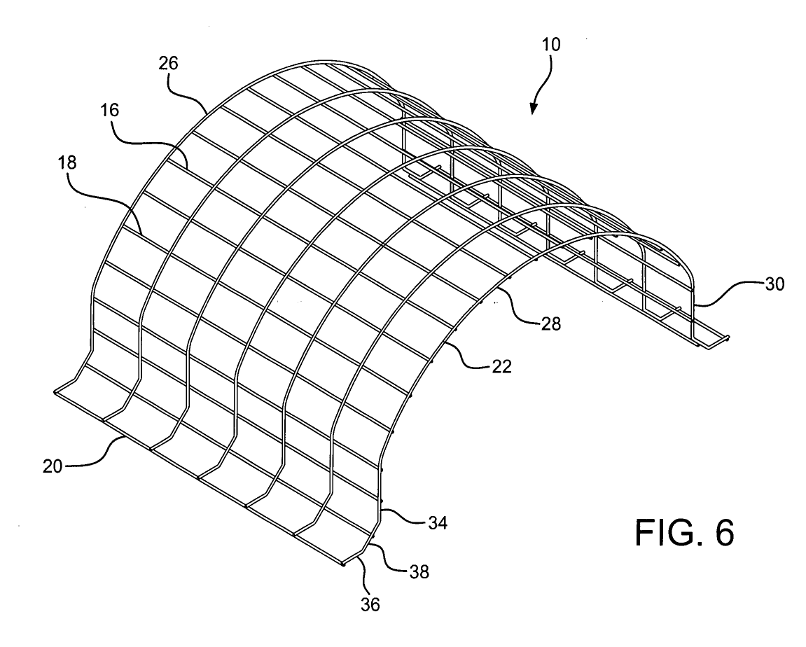

As perhaps best shown in FIGS. 2 and 4, each of the transverse bars such as bar 22 has a central portion 28 and end portions 30 and 32. The central portion is formed into an arch and is adapted to overlie the skylight 12 when it is secured in place as shown in FIG. 2. The end portions 30 and 32 of the transverse bar 28 (and all of the other transverse bars) are identical to each other. That is, there is no right or left side nor front and back end. The screen 10 is symmetrical. Accordingly, only end portion 32 of the transverse bar 22 will be described in detail. It should be understood that the end portion 30 of the transverse bar 22 is constructed in substantially the identical manner.

End portion 32 of the transverse bar 22 includes a substantially vertical section 34 that merges into the central portion 28 and a substantially horizontal end section 36 that extends outwardly away from the skylight 12. The horizontal end section 36 acts, essentially, as a foot allowing the screen 10 to rest on and be supported by the roof 14.

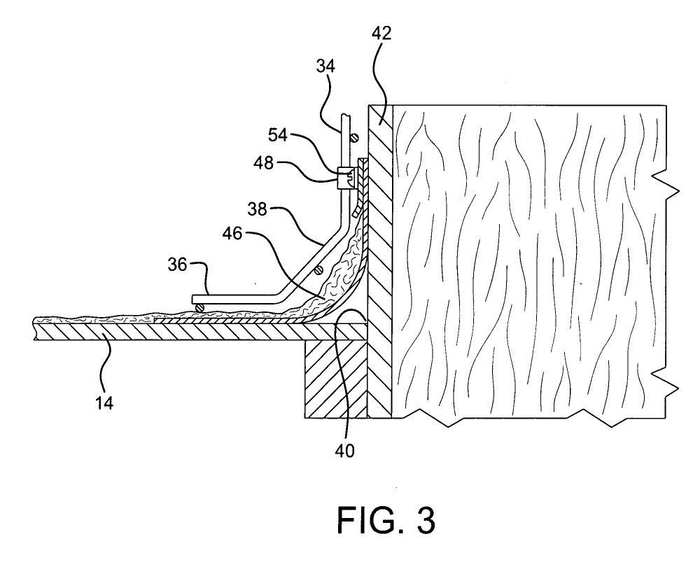

Located between the substantially vertical section 34 and the substantially horizontal section 36 is an intermediate section 38 that functions as a transition between the vertical section 34 and the horizontal section 36. As best seen in FIG. 2, the intermediate section 38 extends at an angle of approximately 45° from the vertical section 32 (and from the horizontal section 36) and is spaced from the corner formed between the roof 14 and the skylight 12. More particularly, the skylight 12 includes a frame having spaced apart vertical walls 42 and 44. The intermediate section 38, being spaced from the corner formed by the vertical wall 42 and the roof 14, allows the screen 10 to accommodate flashing and other roofing materials such as shown at 46 in FIG. 3. If the vertical section 32 and horizontal section 36 at the end of the transverse bars met at right angles, the screen would not fit properly over the skylight as the roofing material 46 would interfere and be in the way.

The skylight screen 10 is attached to the skylight frame through the vertical frame members 42 and 44 by the use of a plurality of clips such as shown at 48 and 50. As illustrated in FIG. 3, the clip 48 includes a portion that surrounds the vertical section 34 of the end of the bar 22 and one or more screws 54 that secure the clip to the vertical wall 42 of the skylight frame.

While it is possible to utilize a clip 48 or 50 on each of the transverse bars, this is normally not necessary. As should be readily apparent to those skilled in the art, the clips are merely positioning the screen 10 in place and to prevent movement by wind forces and the like. Downward forces on the screen 10 as may be caused by a worker falling on the same are taken up by the horizontal feet 36 pushing down directly on the roof 14. Thus, undue forces are not placed on the skylight frame.

As should also be readily apparent to those skilled in the art, the specific shape and appearance of the skylight screen 10 shown in the drawings is by way of example only. It is obviously possible to use more or fewer longitudinal and/or transverse bars. Furthermore, the size of the arch and the height will depend on the size and height of the skylight 12. Even further, while the drawings show distinct vertical sections of the transverse bars, it is also possible to have a more gradual transition from the arched portion to the vertical sections so that there is not a clear demarcation between the two. Similarly, while the intermediate section 38 between the vertical section 34 and the foot 36 is straight and is clearly distinguishable from the other two sections, it is also possible to design the ends of the transverse bars so that there is a more continuous curved transition between the sections.

The present invention may be embodied in other specific forms without departing from the spirit or essential attributes thereof and accordingly, reference should be made to the appended claims rather than to the foregoing specification as indicating the scope of the invention.

We claim:

1. A screen for a skylight wherein said skylight is mounted on a substantially flat roof and which includes a frame having spaced apart vertical walls extending upwardly from said roof, said screen comprising:
a plurality of longitudinal bars and a plurality of transverse bars, said longitudinal bars being secured to said transverse bars so as to form a plurality of rectangular openings;
said transverse bars having a central portion and end portions;
the central portions of said transverse bars forming an arch and being adapted to overlie said skylight when said screen is secured in place;
said end portions of said transverse rods including a substantially vertical section merging into said central portion and a substantially horizontal end section extending outwardly, said substantially horizontal end section being adapted to act as a foot allowing said screen to rest on and be supported by said roof, and
a plurality of clips for securing said substantially vertical section of at least some of said transverse rods to said space apart vertical walls of said skylight frame.

2. The screen for a skylight as claimed in claim 1 wherein said end portions of said transverse rods include an intermediate section between said vertical section and said horizontal section, said intermediate section forming a transition between said vertical section and said horizontal section and being spaced from the corner formed between said roof and each of said vertical walls of said skylight frame.

3. The screen for a skylight as claimed in claim 2 wherein said intermediate sections extend at an angle of approximately forty five degrees from said vertical sections.

4. The screen for a skylight as claimed in claim 1 wherein said longitudinal bars and said transverse bars are made of metal.

5. The screen for a skylight as claimed in claim 4 wherein said longitudinal bars are secured to said transverse bars by welding.
